(19) United States
(12) Patent Application Publication
(10) Pub. No.: US 2007/0067145 A1
(43) Pub. Date: Mar. 22, 2007

(54) Method and apparatus for function allocation and interface selection

(75) Inventors: Christopher A. Miller, Minneapolis, MN (US); Robert P. Goldman, Minneapolis, MN (US); Harry B. Funk, Minneapolis, MN (US); Peggy Wu, Minneapolis, MN (US); John W. Meisner, Minneapolis, MN (US); Joshua D. Hamell, Minneapolis, MN (US); Marc D. Chapman, Minneapolis, MN (US); Peggy Norquist, Minneapolis, MN (US)

Correspondence Address: SMART INFORMATION FLOW TECHNOLOGIES, LLC D/B/A;SIFT, LLC, 2119 OLIVER AVENUE SOUTH, MINNEAPOLIS, MN, 55405, US

(73) Assignee: SIFT, LLC, Minneapolis, MN (US)

(21) Appl. No.: 10/711,126

(22) Filed: Aug. 25, 2004

(51) Int. Cl. G06G 7/48

(52) U.S. Cl. 703/6

(57) ABSTRACT

A method and apparatus for creating, modifying, elaborating and analyzing a task template is disclosed. The task templates created or modified are preferably stored in a repository of templates which are used for further task template specification. The task templates, and processes which operate

### FEDERAL RESEARCH STATEMENT

This invention was made with Government support under contract DAAH01-02-C-R163 awarded by the US Army Aviation and Missile Command. The Government has certain rights in the invention.

### BACKGROUND OF INVENTION

As automation becomes more sophisticated and complex, systems in which humans and automation work together to solve a problem are becoming increasingly common. Initially, the form of interaction between human and automation was fixed and simple. A fixed interaction approach was only suitable for a small set of problems. If the system was asked to solve a larger range of problems, then more modes of interaction were designed for the human-automation system. Still, the systems often had only a single means of performing a function—a single task allocation approach. If the system had more than one task allocation approach, the human would choose the approach. Humans do not reliably select the optimal task allocation approach, since they are not skilled at multi-step lookahead with probabilistic reasoning. In particular, in complex situations with significant time pressure, the human is least capable of performing the optimal task allocation, since their available cognitive resources are dedicated to problem solving tasks, as opposed to optimizing the human-automation function allocation.

The task allocation problem is particularly relevant to systems with interactions that have been called “mixed initiative,” “variable initiative,” or “adjustable autonomy”, because either the human or the automation can take initiative to perform most tasks and the level of autonomy afforded to either may vary depending on context, goals and authorizations. Sophisticated automation systems in deep space missions (both manned and unmanned), industrial processing plants, energy generating facilities, air traffic control, building environmental control systems, and many types of enterprise management and logistics operations all need to operate independently for large stretches, yet also must obey human intent and adjust to that intent whenever it is expressed. Finally, systems with variable initiative in the piloting function, such as uninhabited vehicles (UVs) and “optionally piloted vehicles” (OPVs) are important representatives of this class of systems.

To operate in a variable initiative paradigm successfully, such automation needs to be able to inform the human of the consequences and implications of various actions, be able to identify dangerous situations and unexpected opportunities for success or efficiencies, and be able to know when it needs human help or decisions and seek them. And all this must be done quickly and with minimal error. To achieve these objectives humans must be able to interact with the vehicle automation very flexibly and at a variety of levels ranging from fully manual control to fully automated control depending on what they feel is best in the current situation.

We provide an extremely flexible and powerful variable initiative interaction that mimics the levels of freedom, and efficiency, that humans have in sharing tasks with other humans. We have developed a task delegation process that allows maximal flexibility for machine-to-human and human-to-machine control transfers with minimal cognitive, psychomotor and sensory requirements (i.e., workload) for the human. At the same time, we have worked to ensure that such delegation interactions remain stable and feasible. We have developed an architecture for flexible, variable initiative, human interaction with automation. In this architecture both human and automation can flexibly trade off the control of a vehicle or other automated system and can provide inputs to each other at various levels of a task hierarchy. We call this general architecture a tasking or delegation interface because it allows humans to “task” or delegate to automation in the same manner they would intelligent human subordinates. Systems we have built have used the metaphor of a sports team's playbookas a “vocabulary” for human and automation to communicate about intent and outcomes. The playbook also achieves tasking efficiencies by compiling a set of instructions into a single, commandable “play” that can be further specified or modified if time permits or context demands. With appropriate representations and reasoning tools, we have demonstrated that this playbook architecture can produce provably correct control behaviors for UVs in simulation.

Transfer of control from human to automation should be viewed as a delegation or tasking process. Function performance can be viewed as a hierarchical organization of tasks and/or goals. Thus, “transfer of control” is more properly the job of expressing intent about, and perhaps negotiating over, who is to perform which of the sub-tasks in the task hierarchy and in what way (i.e., under what constraints). The challenge in providing a mechanism for this kind of transfer of control from human to automation is to permit the human to express his or her intent to the automation in a way that is quick and easy enough to be feasible in an operational setting, is comprehensible by both human and automation parties, and doesn't disrupt the stability of control that should exist in a system in which transfers don't take place. For most system control applications, it is important that the system remain stable over a transfer of control. By stable, we mean that the system should not exhibit large and abrupt changes in its state trajectory. Systems which become unstable can exhibit undesirable behaviors, including ones which result in damage or destruction of the system being controlled. The stability requirement becomes more complicated the more variable the transfers become.

In many ways, the transfer of control from automation back to the human is a harder problem than transfer in the other direction. Vehicle-to-human transfer is also a new problem. If the human wishes to take authority from automation, then the system must provide the user all the relevant contextual information. S/he must be made aware of the set of ongoing and related activities which automation has been managing and which human input may affect or disrupt. More difficult still, when the automation must transfer control back to the human, additional problems arise. First, automation must verify that the human's physical and cognitive state is adequate to receive the control transfer. Is the crew member conscious? Panicked? Incapacitated? Once these hurdles are overcome, not only must the system be able to communicate the full set of contextual information described above for a human-requested transfer; it must also be able to communicate the type of control function being transferred. Automation may also need to inform the human what the system wants or thinks the s/he should do about that function. All of this information must be transferred quickly enough that the human can absorb it and be prepared when the transfer occurs. Finally, there must be control authority left for the human to exercise. If the system only hands control back to the human when all possible options have been exhausted then little will be accomplished beyond allowing the human to “be responsible for” an inevitable failure.

In order to provide stable variable initiative control one needs an analytic technique that would be able to determine which tasks or methods would be feasible for a human or a machine to perform in any given context. There are two primary challenges: First one must identify variable initiative and control techniques appropriate to the various portions of the overall task hierarchy (of mission and vehicle control) and develop a “delegation protocol” for exchanging control and authority over those tasks between human and automation. The delegation protocol must encompass all needed control exchange actions and constraints, and it must be executable within the constraints imposed by the domain (e.g., time and human workload limitations).

The second challenge is developing a mechanism for checking control transfer acts for feasibility, stability and correctness. While prior research in human-computer interaction (HCI) has studied control transfer acts, this work does not meet the needs of the variable initiative domain because it does not consider human performance constraints including the time required to effect the transfer and the human workload required to understand the needed task inputs and constraints. Further, prior HCI work only partially ensures that human task inputs (whether they come as directly commanded actions, request to take control of a specific task or requests to transfer control with a specific method or objective) are themselves feasible, stable and correct.

There are a wide variety of tools and techniques for modeling, simulating and predicting human task performance times and accuracies. The vast majority of these tools rely on task models of human performance to compute, for example, the workload that a human would experience in attempting to perform a set of concurrent tasks via a set of given set of interfaces. The human's performance time and accuracies can be systematically adjusted based on assumptions about his/her experience and training, fatigue, and disruptive factors in the task performance context. Such disruptive factors might include vibration, smoke/dust, Mission Oriented Protective Posture (MOPP) gear, etc. These models also adjust performance times and accuracies by the effects of violating workload thresholds for the simulated human. When the simulated human attempts to perform a set of tasks whose associated workload violates a threshold, the model will produce task postponement, task errors, or both.

While we believe that this traditional approach using human performance simulation/analysis (HPSA) to determine stability and performability of various task allocations is entirely viable, such prior art is sub-optimal from a number of perspectives. First, prior HPSA approaches impose the need to analyze HPSA scenarios using a timeline by timeline approach. This is a time consuming process.

Another important HPSA limitation is the lack of an overt consideration of optimization. The results of an HPSA run will provide evidence for or against the ability of a single method under examination to provide adequate performance in terms of time and accuracy constraints. However, such simulations do not provide any tool support for choosing the best of a set of methods. We could, perhaps, provide the ability to tradeoff various alternative methods via a weighted combination of low workload, quick performance time and high performance accuracy. Unfortunately, we can't evaluate methods in isolation since each of a set of methods might be optimal in different circumstances. In fact, this becomes a complex tradeoff space and an ability to understand and analyze that full space simultaneously would be advantageous.

Another important limitation of HPSA approaches is that they analyze performance feasibility only on a moment-by-moment basis with no consideration for optimization over time. That is, the results of an HPSA run can be used to determine whether or not, at the time it was activated, a given method of task performance was capable of being performed within time and accuracy bounds, but it cannot provide information about whether performing that task in that way at that time was a good or optimal use of scarce resources such as the pilot's time and attentional capacity. For example, HPSA can determine whether or not a “Fully Manual” method will be viable at any point during the mission, but it cannot tell you (at least not in any convenient format) whether the portion of pilot attention devoted to that task might have been more usefully held in reserve for a more important task which might arise in the near future.

### SUMMARY OF INVENTION

The current invention overcomes the limitations of prior art by providing a task specification, elaboration, and analysis apparatus. In the preferred embodiment, a user selects a task template from among a plurality of predefined templates. Said task template holds information regarding alternative ways the task can be performed, each alternative comprising a directed graph of subtasks, necessary control and information parameters for performance of the task, the actors that may perform the task, conditions necessary for performance of the task, and conditions that the task may achieve. A user edits the template to admit a subset of the task instances encompassed by the selected template. The user adjusts the template by modifying the process flow defined by the template, by constraining the parameter bindings permissible for instances encompassed by the template, and by constraining the permissible process flow for instances encompassed by the template, among other possible template editing actions. Alternatively, the user may also remove or relax constraints, thereby admitting additional task instances.

A description of the context in which the task is to be performed is provided to the apparatus. In one embodiment, the context is provided by a simulation environment that generates a plurality of environmental state parameters and their associated values, such values being time-dependent. In an alternative embodiment, the context is provided by sensed parameter values obtained from external sources. The user may choose a particular environmental state description in which to perform the tasks from among a plurality of stored environmental state descriptions.

A task elaboration and encoding function further refines and expands the task template to identify feasible bindings, necessary task methods and allowed function allocations in view of a situation context in which the task instances are to be analyzed. The feasible task instances are elaborated sufficiently to allow analysis by a desired analysis tool. In one embodiment, the task instances are in the form of a Markov Decision Process representation. In another embodiment, the task instances are in the form of a directed graph of task nodes connected by arcs. The arcs and nodes may be represented graphically with shapes and arrows, but may also be represented by other well known means, such as prepositional representations, including but not limited to programming language syntaxes and dialects of XML, as well as matrix representations and others.

A plurality of arcs may connect one node to a plurality of following task nodes, and each arc may have a likelihood of arc traversal associated with it. Further, the task node may have a function allocation associated with it. Further, the function allocation for that task may have a utility associated with it that represents the desirability of performing the task using the associated function allocation. Further, the function allocation may have information and interaction requirements associated with it that allow delineation of interface requirements to support the function allocation.

In one embodiment, the elaboration function compares the time-dependent environmental state description to necessary conditions for execution of task nodes. If environmental conditions do not permit execution of previously selected task nodes, the elaboration function may identify alternative bindings, methods and function allocations that allow execution of the task nodes so identified.

The task instances so determined are provided as input to an analysis system to determine characteristics and metrics associated with performing the task according to the task instances so determined. In one embodiment, the task instances are analyzed by means of a Markov Decision Process solver to provide an optimal function allocation for each task node in the graph. In an alternative embodiment, the task instances are analyzed by means of a simulation that provides a user with various views of the task execution. In one such view, the user is presented with a timeline view of the task nodes that are active during each time segment of the simulation duration. In another view, the user is presented with a simulated view of the environment state, such state including the effects of task nodes active in the simulation. In still another embodiment, the task instances are provided to the actor or actors identified as permissible by the planning system as control instructions or directives for said actor or actors.

### BRIEF DESCRIPTION OF DRAWINGS

FIG. 1 shows a view of an embodiment of the present invention.

FIG. 2 shows a view of an embodiment of an output representation of the present invention.

FIG. 3 is a view of an embodiment of a stored representation created with the present invention.

FIG. 4 is a view of an alternative embodiment of the present invention.

FIG. 5 is a flow chart diagram of a method embodiment of the present invention.

FIG. 6 is an expanded flow chart diagram of a portion of the method embodiment of the present invention found in FIG. 5.

FIG. 7 is an expanded flow chart diagram of a portion of the method embodiment of the present invention found in FIG. 5.

FIG. 8 is an expanded flow chart diagram of a portion of the method embodiment of the present invention found in FIG. 6.

FIGS. 9(a)-9(b) show embodiments for a portion of the method embodiment found in FIG. 6.

FIGS. 10(a)-10(b) show alternative embodiments of the method embodiment found in FIG. 6.

FIG. 11 shows an embodiment of a portion of the method embodiment found in FIG. 7.

FIG. 12 shows an alternative embodiment of a portion of the method embodiment found in FIG. 7.

FIG. 13 shows an alternative embodiment of a portion of the method embodiment found in FIG. 7.

FIGS. 14(a)-14(d) show a representative sample of devices upon which the present invention may be utilized.

### DETAILED DESCRIPTION

In the following detailed description of the embodiments, reference is made to the accompanying drawings which form a part hereof, and in which is shown by way of illustration specific embodiments in which the invention may be practiced. It is to be understood that other embodiments may be utilized and structural changes may be made without departing from the scope of the present invention.

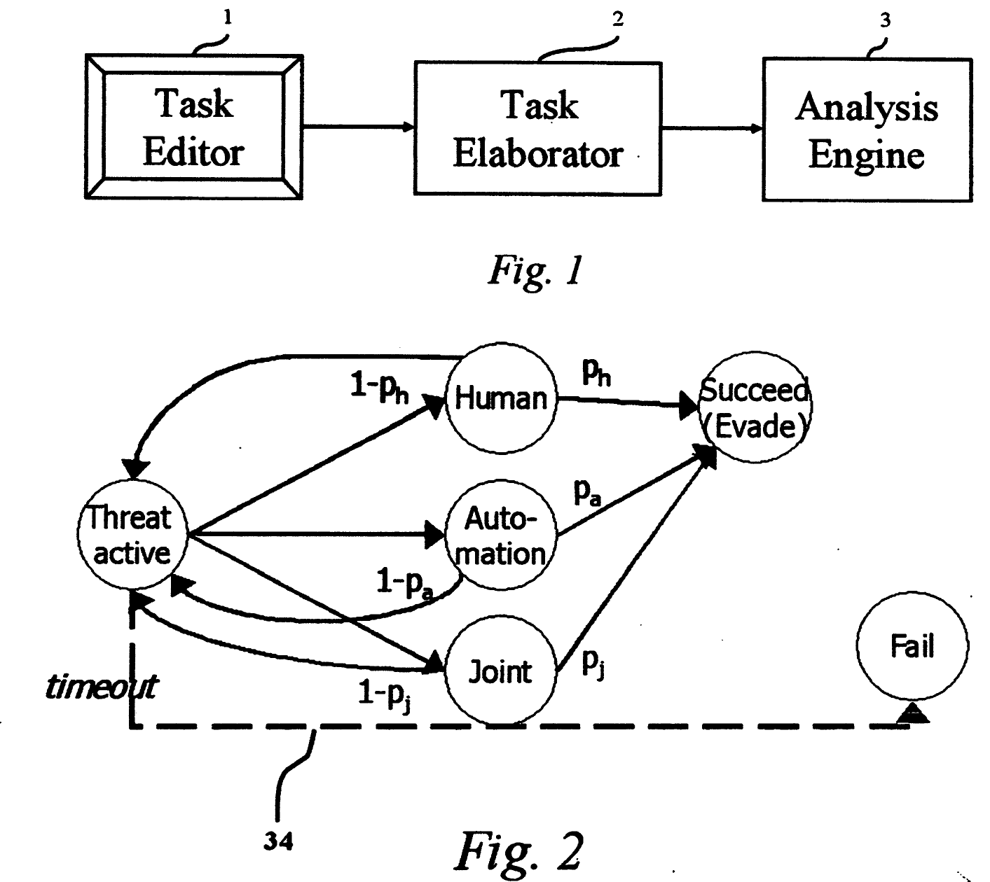

Systems and methods in accordance with the present invention provide a analytic capability for optimized function allocation and interface specification for said function allocation. FIG. 1 shows three components in one embodiment of the system. A Task Editor 1 provides a constrained task template to a Task Elaborator 2. The Task Elaborator 2 translates the task template to a form suitable for the Analysis Engine 3. The Task Elaborator 2 uses the output of the Task Editor 1 with a specification of the Analysis Engine 3 input format and other information as may be necessary and available to generate input data suitable for the Analysis Engine 3. The Analysis Engine 3 performs computations specific to the type of analysis for which it is intended. In one embodiment, the Task Elaborator 2 produces an output format as shown in FIG. 2, a Markov Decision Process (MDP) Representation 34. The MDP Representation 34 forms suitable input for an embodiment of the Analysis Engine 3 consisting of a MDP solver.

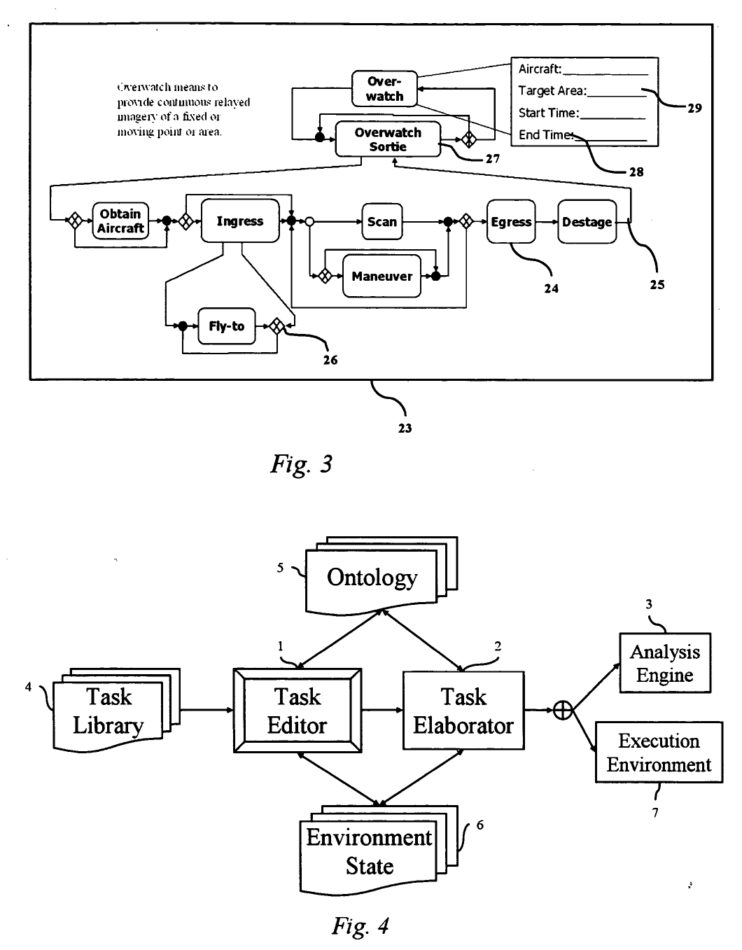

FIG. 3 shows a Task Template 23 that a user creates using the Task Editor 1. Said Task Template 23 consists of a plurality of Task Nodes 24, Node Connectors 25, and Connector Joins 26. Certain distinguished Task Nodes 27 may themselves be examples of Task Templates 23, thereby forming a hierarchy of Task Templates 23 of arbitrary complexity, FIG. 1 1 showing one such hierarchy 37 Each Task Node 24 contains a plurality of Task Parameters 28, each Task Parameters 28 having a Task Parameter Value 29.

FIG. 4 is a view of another embodiment, in which the Task Editor 1 may obtain a Task Template 23 from a Task Library 4 that contains a plurality of Task Templates 23. Further, the Task Editor 1 may reference an Ontology 5 containing object classification and other information, said Ontology being used to constrain the allowable Task Parameter Values 29. Further, the user may choose to define or choose an Environment State 6 that describes the conditions of the simulated or real world in which the elaborated Task Template 23 will be analyzed or executed. Further, in one embodiment of the present invention, the elaborated Task Template 23 is provided to an Execution Environment 7 that performs the process described by the elaborated Task Template 23.

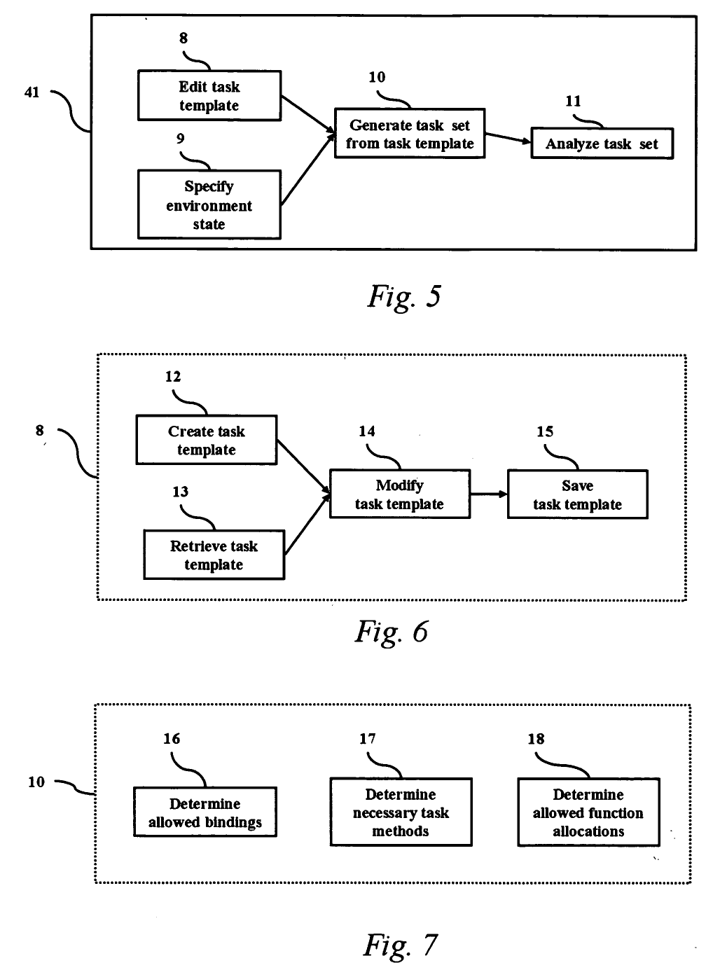

FIG. 5 is a flowchart depiction of a method 41 embodying the present invention. Method 41 comprises editing a task template in block 8, specifying an environment state in block 9, generating a task set that satisfies the task template specification in the context of the environment state in block 10, and analyzing the task set in block 11 according to the capabilities of the Analysis Engine 3 employed. In one embodiment of the current invention, the analysis of block 11 is performed by executing the task set in a real world environment to determine the outcome.

As shown in FIG. 6, editing the task template in block 8 may further comprise creating the task template in block 72, retrieving a task template in block 13, modifying the task template in block 14, and saving the modified task template in block 15.

As shown in FIG. 7, modifying the task template in block 14 further comprises the steps of modifying the process flow structure of the task template in block 19, modifying the parameters and allowable binding specification in block 20, modifying the process flow constraints in block 21, and saving the task template in block 22.

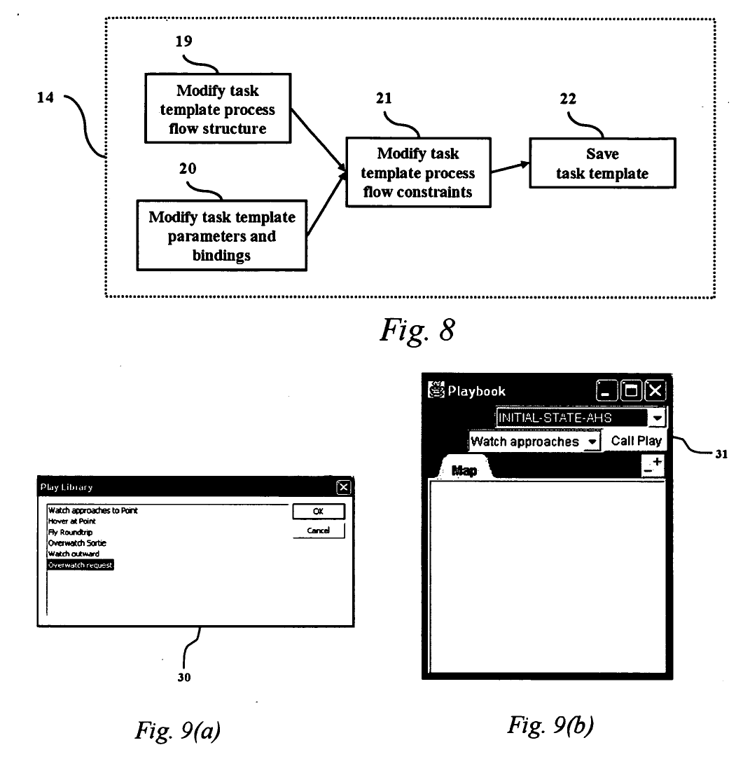

As shown in FIG. 8, generating the task set in block 10 further comprises the steps of determining allowable parameter bindings in block 16, determining the necessary task methods in block 17, and determining the allowed function allocations in block 18. In one embodiment of the present invention, the Task Elaborator 2 is a automated hierarchical planner that uses this Environment State 6 along with constraints and information contained in the Task Template 23 and Ontology 5 to generate an elaboration of the Task Template.

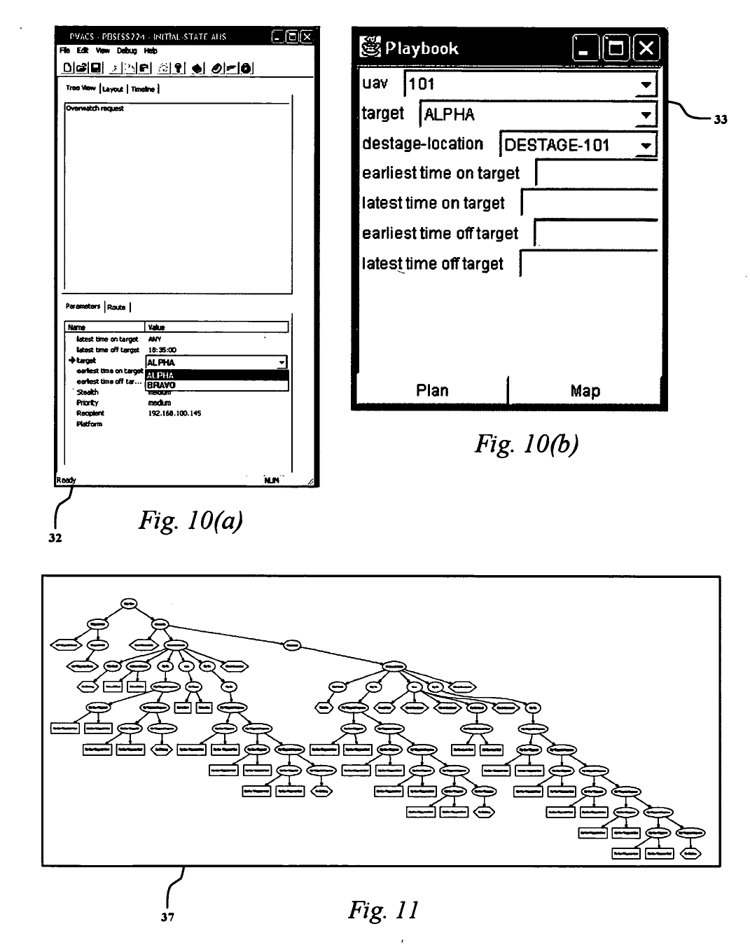

FIG. 9(a) shows a interface that allows a user to invoke the method of block 13, and FIG. 9(b) shows an interface that allows a user to perform the methods of blocks 9, 13 and 20. FIG. 10(a) shows an alternative interface to perform the method of block 20, combined with an interface to perform the method of block 21. FIG. 10(b) shows another alternative interface to perform the methods of blocks 20, 10, and 7. FIG. 11 shows an interface that allows a user to invoke the methods of blocks 19 and 21, and further for selecting the task for which the user will invoke the methods of block 20. FIG. 12 shows an alternative interface 35 to perform the methods of blocks 19 and 21, and to select the task for which the user will invoke the method of block 20. Further, the interface 35 is used to communicate the constraint that was used by the Task Elaborator 2 to select or reject a task or task allocation.

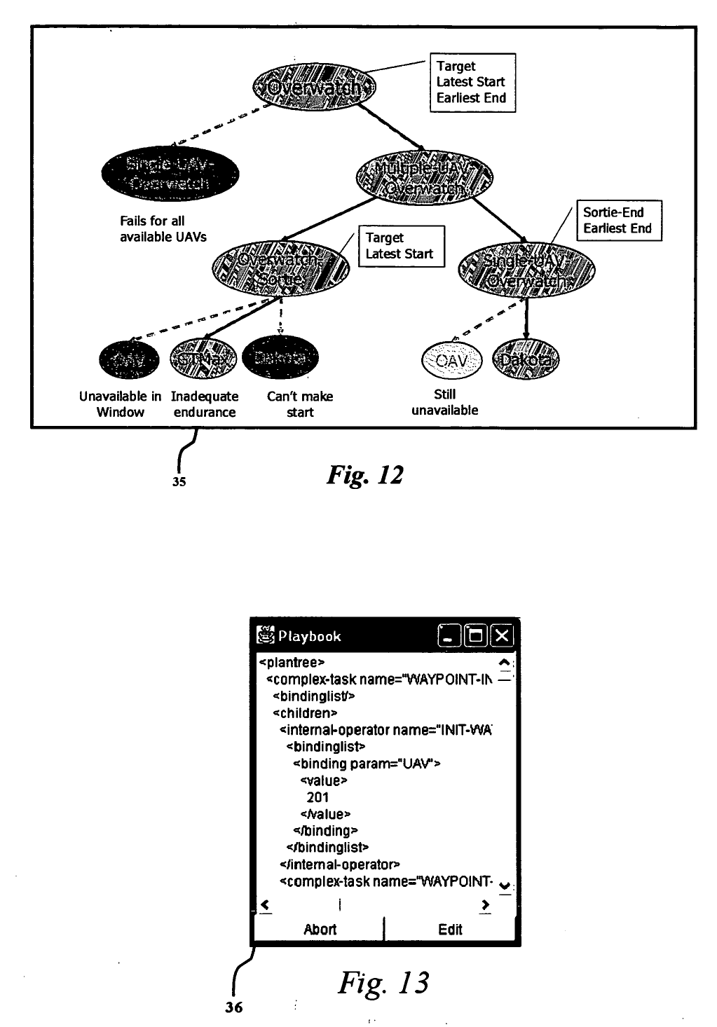

FIG. 13 shows one embodiment of the format and content which ar used in the Task Template 23, the Task Hierarchy 37, and as inputs to the Analysis Engine 3 or Execution Environment 7. Further, this form and content when presented in an interface such as that shown in block 36 allows the user to perform the methods of block 14.

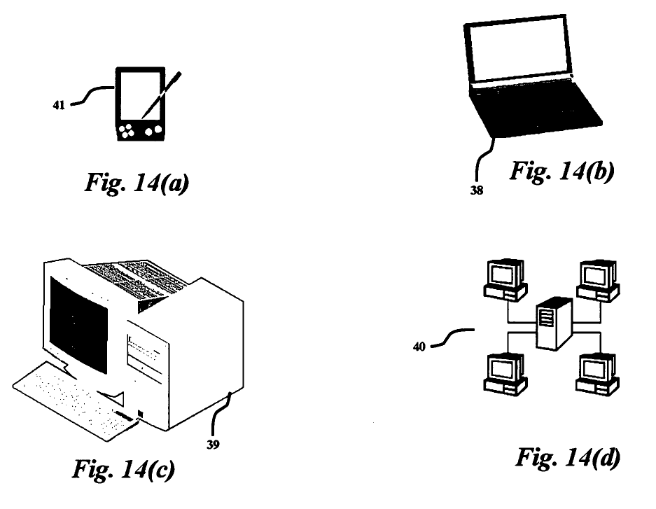

A user employs standard input devices found on a computer systen 38, 39, 40, 41 shown in FIG. 14 to interact with the current invention which is housed on a plurality of such systems.

What is claimed is:

1. An apparatus comprising
a. a task editor
b. a task elaborator and
c. an analysis engine.

2. The apparatus of claim 1, wherein the task editor is used to create a specification of allowable task methods, parameters, and parameter bindings, said specification suitable as input to a task elaborator.

3. The apparatus of claim 2, wherein the task elaborator is an automated planner. [Claim 4]

4. The apparatus of claim 3, wherein the task editor obtains the initial task template from among a plurality of stored task templates.

5. The apparatus of, wherein the apparatus further references an environmental state definition, said state definition being time dependent.

6. The apparatus of , wherein the apparatus further references an ontology of task information that defines allowable methods, parameters, and parameter bindings

7. The apparatus of , wherein the analysis engine is an simulator.

8. The apparatus of , wherein the analysis engine performs human workload estimation.

9. The apparatus of , wherein the analysis engine is a real-world exercise whose results are interpreted post-exercise.

10. The apparatus of , wherein the task elaborator creates a Ma kov Decision Process (MDP) representation.

11. The apparatus of , wherein the analysis engine is a MDP solver.

12. A method employed by the apparatus of , comprising
a. editing a task template
b. specifying the environmental state in which the task template is to be examined
c. generating a plurality of task instances which are allowable given the task template specification and environmental state
d. analyzing the task templates thus generated.
